(19) United States
(12) Patent Application Publication
(10) Pub. No.: US 2012/0049039 A1
(43) Pub. Date: Mar. 1, 2012

(54) VIBRATION ISOLATION SYSTEM FOR A MOWER

(75) Inventors: Ronald SCHEFFLER, Beaver Dam, WI (US); Anthony S. WEBER, Lake Mills, WI (US); Richard Lee BEDFORD, Watertown, WI (US); Eric HINTZ, Johnson Creek, WI (US)

(73) Assignee: SCHILLER GROUNDS CARE, INC., Southampton, PA (US)

(21) Appl. No.: 13/217,897

(22) Filed: Aug. 25, 2011

Related U.S. Application Data
(60) Provisional application No. 61/376,943, filed on Aug. 25, 2010.

(51) Int. Cl. F16F 15/02

(52) U.S. Cl. 248/636

(57) ABSTRACT

A vibration isolation system for a lawn mower having a chassis supporting a foot platform, a first motion control arm, a second motion control arm and a seat has a first vibration isolation subassembly coupling the foot platform to the chassis. The first vibration isolation subassembly is configured to attenuate foot platform vibratory motion. A second vibration isolation subassembly couples the first motion control arm and the second motion control arm to the chassis. The second vibration isolation subassembly is configured to attenuate first motion control arm vibratory motion and second motion control arm vibratory motion. A third vibration isolation subassembly couples the seat to the chassis. The third vibration isolation subassembly is configured to attenuate seat vibratory motion.

### CROSS-REFERENCE TO RELATED APPLICATIONS

This application is related to U.S. Provisional Patent Application No. 61/376,943, filed Aug. 25, 2010, incorporated herein by reference, and claims the earlier filing date of the provisional application.

### BACKGROUND OF THE INVENTION

The present invention relates generally to vibration isolation system for a mower, and more particularly, to a multi-path vibration isolation system for a riding lawn mower.

Shock and vibration propagating through the various structural elements of conventional commercial and residential riding lawn mowers are ongoing hazards to which operators of such equipment are exposed. The shock and vibration may occur due to irregularities in the ground over which the mower is driven. Further, the shock and vibration may occur due to the many moving parts of the mower, such as the engine, the tires and/or the cutting blades. Still further, the design of the mower's structural elements such as the chassis or frame and mower deck may provide additional sources of shock and vibration.

Although the ability to turn a mower within the footprint of the mower allows an operator to cut both large areas and small yards, the design and shape of mowers such as zero-turn mowers has exacerbated the problem as the required low center of gravity for such machines places the operator closer to the sources of vibration.

During typical use, an operator occupies a seat located between the drive wheels of the mower and in front of the motor. The operator's feet rest on a metal plate in front of the seat and above the cutting deck. Left and right control arms linked to the transmission and motor are grasped and manipulated by the operator to control the motion of the mower. Under such circumstances, there are at least three paths by which shock and vibration may reach the operator: via the foot plate, the seat and/or the control arms. The shock and vibration experienced by the operator may contribute to operator fatigue and also may cause soreness, numbness, pain, loss of feeling and other adverse physiological effects.

Accordingly, there is a need in the riding lawn mower art for a multi-path vibration isolation system able to attenuate the shock and vibration experienced by an operator.

### BRIEF SUMMARY OF THE INVENTION

Briefly stated, one embodiment of the present invention is directed to a vibration isolation system for a lawn mower having a chassis supporting a foot platform, a first motion control arm, a second motion control arm and a seat. The vibration isolation system has a first vibration isolation subassembly coupling the foot platform to the chassis. The first vibration isolation subassembly is configured to attenuate foot platform vibratory motion. A second vibration isolation subassembly couples the first motion control arm and the second motion control arm to the chassis. The second vibration isolation subassembly is configured to attenuate first motion control arm vibratory motion and second motion control arm vibratory motion. A third vibration isolation subassembly couples the seat to the chassis. The third vibration isolation subassembly is configured to attenuate seat vibratory motion.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is front, left-side perspective view of a riding lawn mower having a vibration isolation system in accordance with a preferred embodiment of the present invention;

FIG. 2 is left-side elevation view of the lawn mower of FIG. 1;

FIG. 3 is a schematic block diagram of the vibration isolation system of FIG. 1;

FIG. 4 is front, right-side perspective view of the foot support platform of FIG. 1;

FIG. 5 is a top perspective view of a front portion of the first vibration isolation subassembly of FIG. 1;

FIG. 6 is a top, left-side perspective view of a rear portion of the first vibration isolation subassembly of FIG. 1;

FIG. 7 is a top perspective view of the vibratory motion attenuation mount of FIG. 4;

FIG. 8 is a top plan view of the vibratory motion attenuation mount of FIG. 7;

FIG. 9 is a elevation view of the cross section of the vibratory motion attenuation mount identified by line 9-9 in FIG. 8;

FIG. 10 is a side perspective view of the energy absorbing mount of FIG. 6;

FIG. 11 is a side elevation view of the energy absorbing mount of FIG. 10;

FIG. 12 is an operator's right-side perspective view of portion of the second vibration isolation subassembly of FIG. 1 coupling the right control arm to the chassis;

FIG. 13 is a right side perspective view of the tapered plate mount of FIG. 12;

FIG. 14 is a top plan view of the tapered plate mount of FIG. 13;

FIG. 15 is a elevation view of the cross section of the tapered plate mount identified by line 15-15 in FIG. 8;

FIG. 16 is an exploded view of the seat of FIG. 1; and

FIG. 17 is a left-side elevation view of the seat of FIG. 1.

### DETAILED DESCRIPTION OF THE INVENTION

Reference will now be made in detail to embodiments of the invention, examples of which are illustrated in the accompanying drawings. The terminology used in the description of the invention herein is for the purpose of describing particular embodiments only and is not intended to be limiting of the invention.

As used in the description of the invention and the appended claims, the singular forms “a”, “an” and “the” are intended to include the plural forms as well, unless the context clearly indicates otherwise. The words “and/or” as used herein refers to and encompasses any and all possible combinations of one or more of the associated listed items. The words “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The words “right,” “left,” “lower” and “upper” designate directions in the drawings to which reference is made. The words “inwardly” and “outwardly” refer to directions toward and away from, respectively, the geometric center of the structure to which reference is made, and designated parts thereof. The terminology includes the words noted above, derivatives thereof and words of similar import.

Although the words first, second, etc., are used herein to describe various elements, these elements should not be limited by these words. These words are only used to distinguish one element from another. For example, a first vibration isolation subassembly could be termed a second vibration isolation subassembly, and, similarly, a second vibration isolation subassembly could be termed a first vibration isolation subassembly, without departing from the scope of the present invention.

As used herein, the words “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The following description is directed towards various embodiments of a tension rod mechanism in accordance with the present invention.

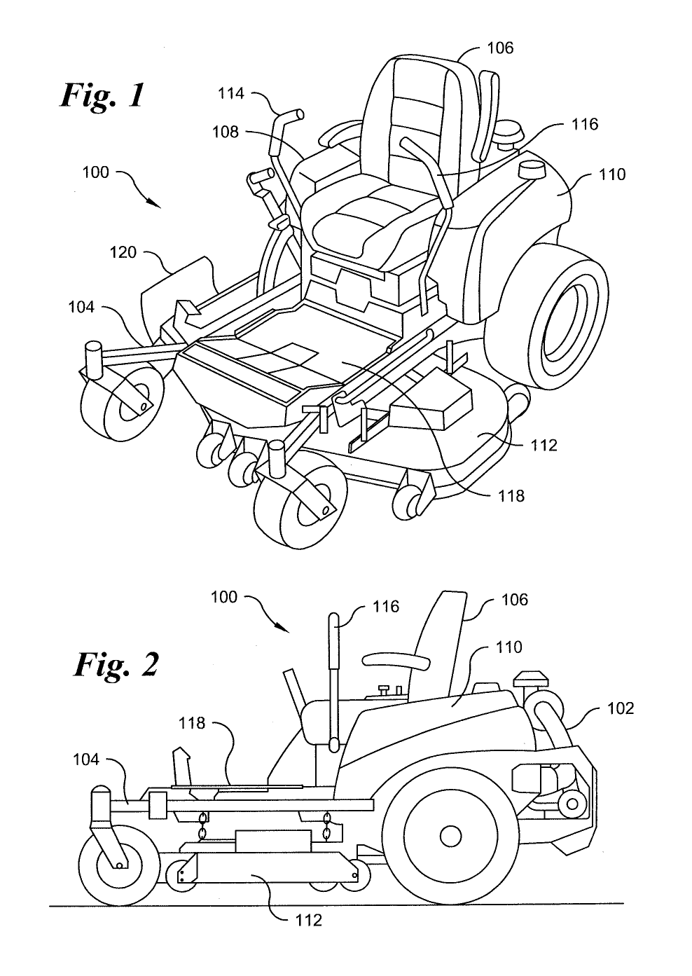

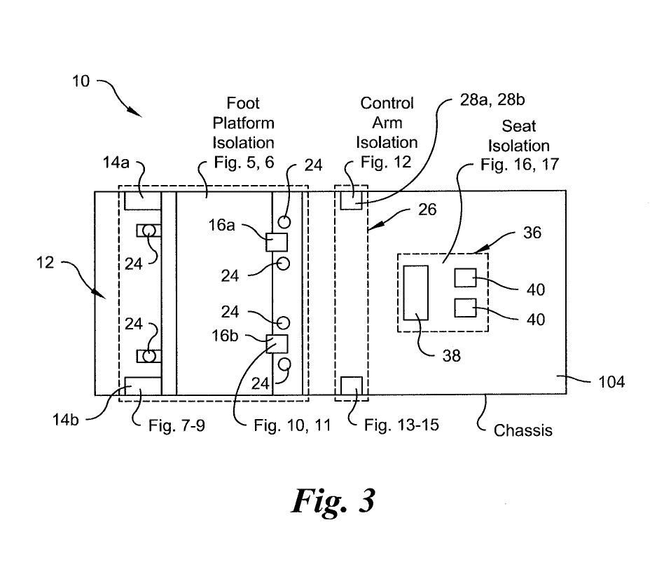

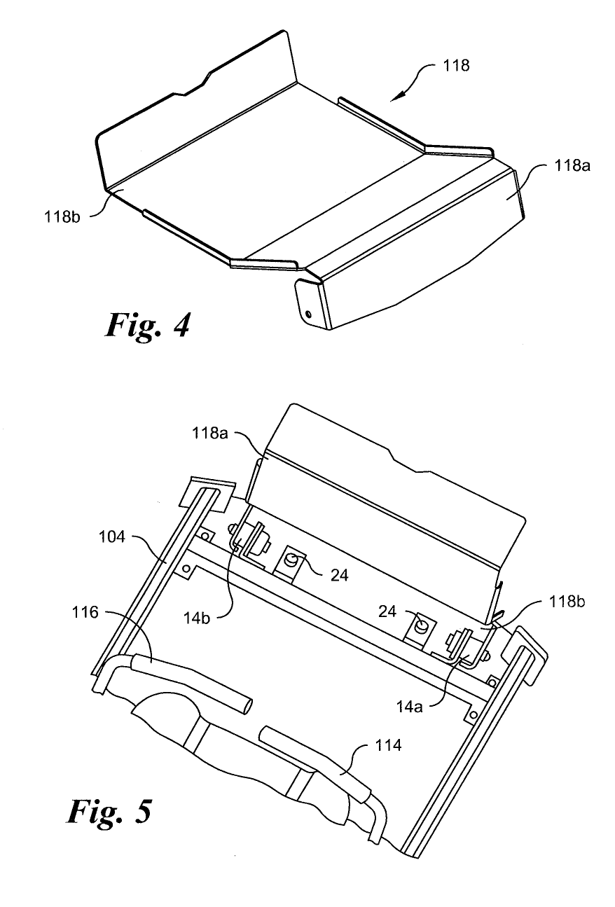

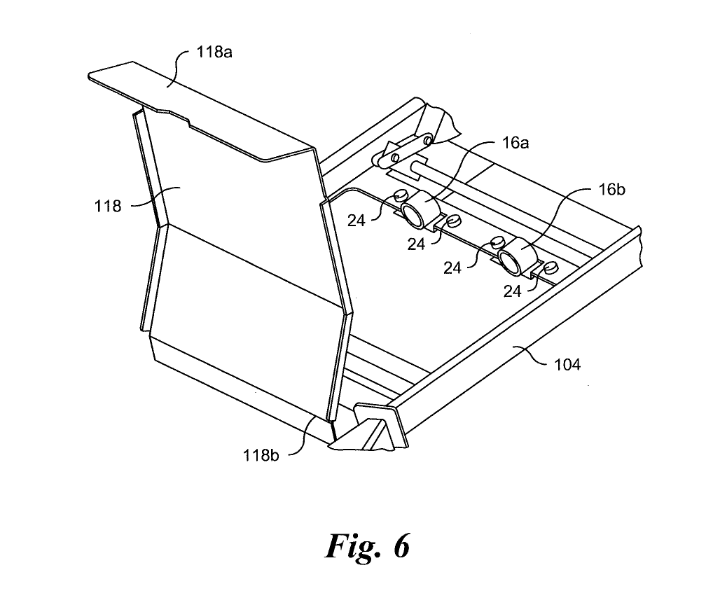

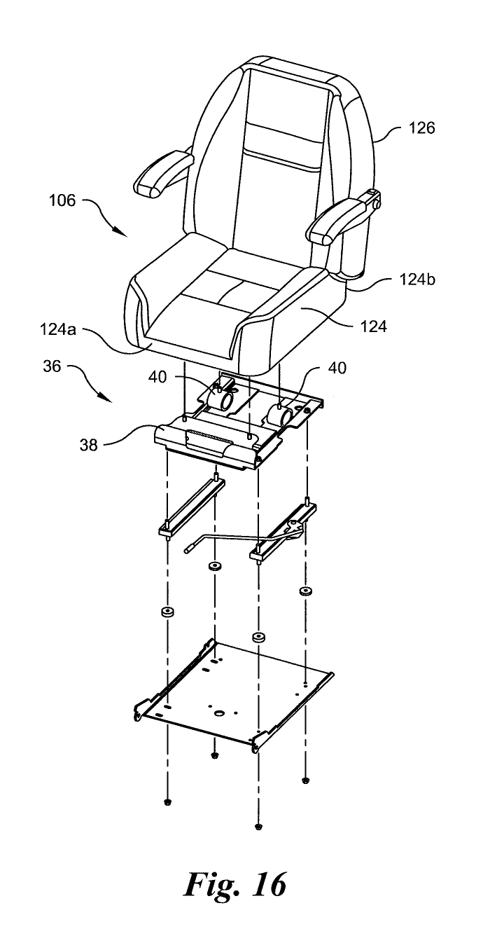

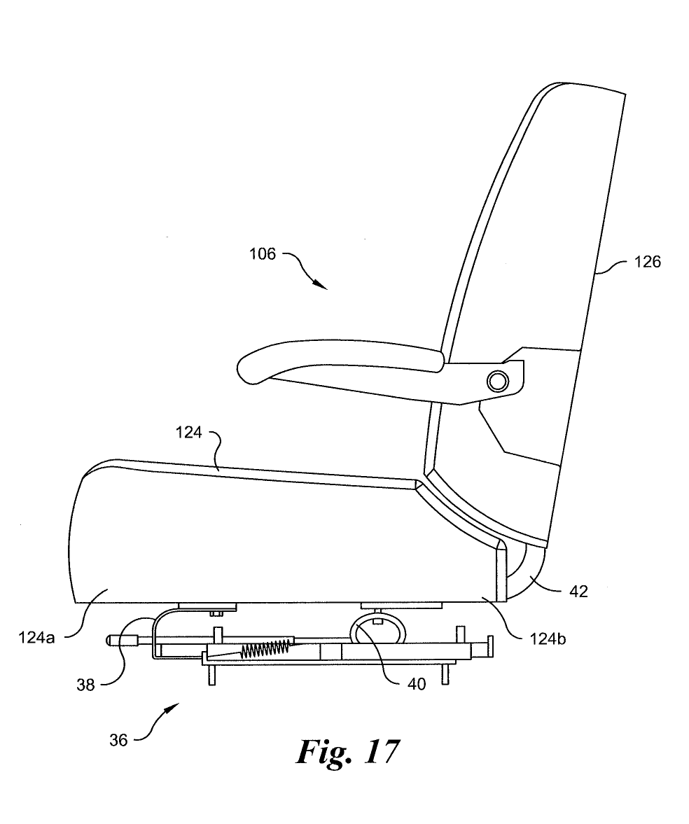

Referring to the drawings in detail, where the same numerals indicate like elements throughout, there is shown in FIGS. 1-17 a first preferred embodiment of a vibration isolation system, generally designated 10, and hereinafter referred to as the “vibration isolation system” 10 in accordance with the present invention. The vibration isolation system 10 is for use with a riding lawn mower, such as the zero-turn mower 100 shown in FIGS. 1 and 2. The zero-turn lawn mower 100 is only one example of a lawn mower which may use the vibration isolation system 10. The other riding lawn mowers for which the vibration isolation system 10 may be adapted may have more or fewer components the zero-turn mower 100, may combine two or more components, or may have a different configuration or arrangement of the components. Accordingly, the zero-turn lawn mower 100 is intended to be a representative platform for describing the features of the present invention and is not intended to be limiting.

The mower 100 is powered by a spark-ignition engine 102 mounted on a chassis 104 behind a seat 106 for an operator. The seat 106 is positioned between two fuel tanks 108, 110 on either side of the mower 100 and above a cutting deck 112. A first (or right) control arm 114 and a second (or left) control arm 116 are provided for controlling the forward and rearward motion of the respective sides of the mower 100. A foot support platform 118 upon which the feet of an operator may rest is provided above the cutting deck 112. A discharge chute 120 is disposed over a side opening (not shown) of the cutting deck 112 for discharging grass clippings.

FIG. 3 is a schematic block diagram of the vibration isolation system 10 showing the general location of the elements comprising the vibration isolation system 10 with reference to a lawn mower having a generally rectangular-shaped chassis. Referring to FIGS. 3-6, the vibration isolation system 10 has a first vibration isolation subassembly 12 coupling the foot support platform 118 to the chassis 104. The first vibration isolation subassembly 12 is configured to attenuate foot platform vibratory motion. The foot support platform 118 has a front portion 118a and a rear portion 118b spaced from the front portion 118a. The first vibration isolation subassembly 12 comprises a first pair 14a, 14b of vibratory motion attenuating mounts rotatably coupling the front portion 118a of the foot support platform 118 to the chassis 104 and a second pair 16a, 16b of energy absorbing mounts coupling the rear portion 118b of the foot support platform 118 to the chassis 104.

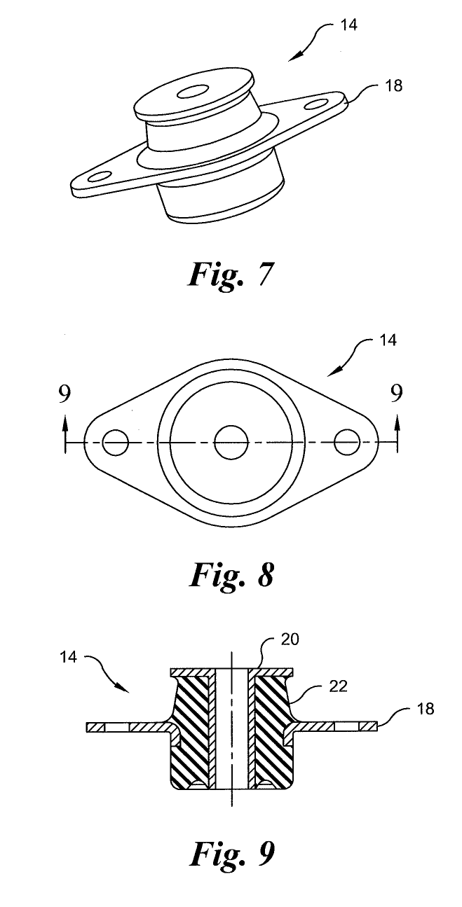

Referring to FIGS. 7-9, in some embodiments, each vibratory motion attenuating mount 14a, 14b preferably is a flange-plate mount 14 comprising a flange plate 18 coupled to a first cylindrical sleeve 20 by an intervening vibratory motion attenuating material 22 such as any of a wide variety of elastomers including, but not limited to, natural rubber and polychloroprene, also known as neoprene. The flange plate 18 is attached to the chassis by conventional fasteners such as a pair of threaded bolts. The cylindrical sleeve 20 is attached to the foot support platform 118 for rotation therewith by a bolt rotatably received in the bore of the sleeve 20.

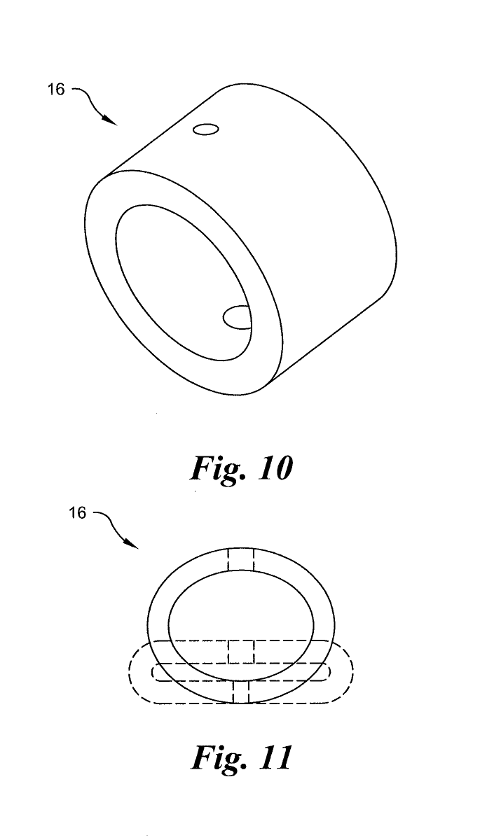

Referring to FIGS. 10 and 11, in some embodiments, each energy absorbing mount 16a, 16b preferably is a cylindrical spring tube 16. In other embodiments, each energy absorbing mount 16a, 16b may be a compression spring (not shown) or other compliant structure. In some embodiments, the first vibration isolation subassembly 12 further comprises at least one stop 24, and preferably a plurality of stops attached to the chassis 104 at locations proximal to each vibratory motion attenuating mount 14a, 14b and each energy absorbing mount 16a, 16b. The stops 24 may be provided to limit a maximum downward displacement of the foot support platform 118 and/or to prevent excessive stressing of the first vibration isolation subassembly 12.

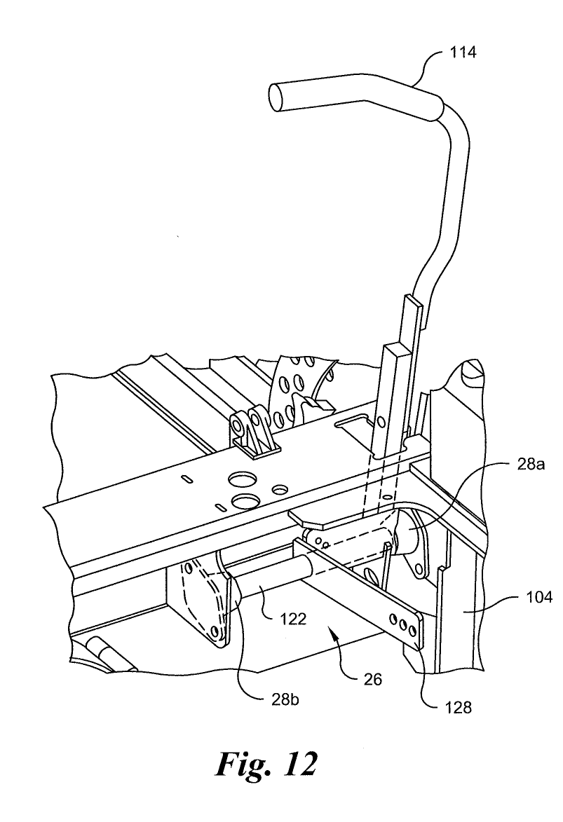

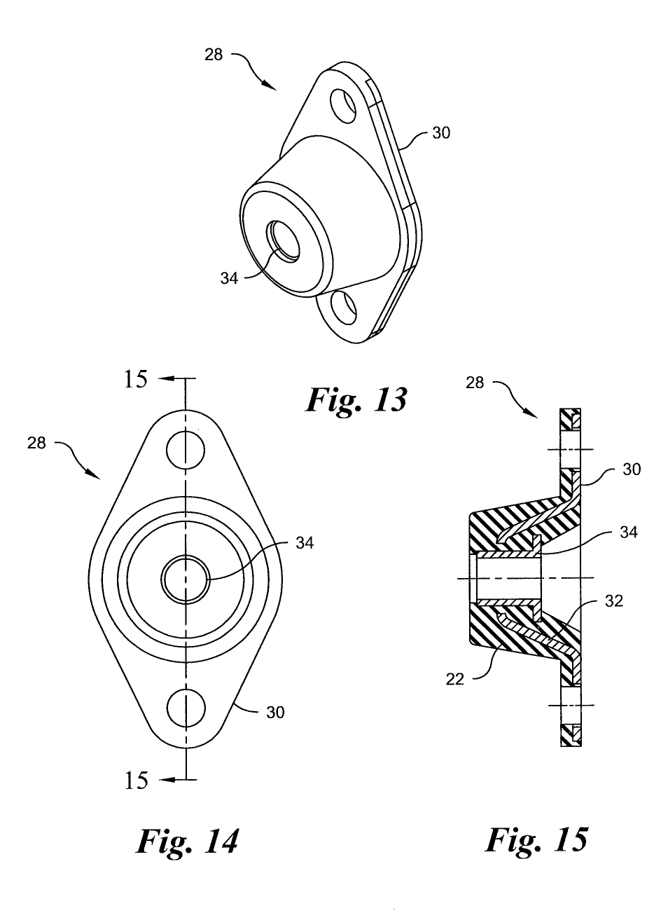

In addition to the first vibration isolation subassembly 12, the vibration isolation system 10 may have a second vibration isolation subassembly 26 coupling the first motion control arm 114 and the second motion control arm 116 to the chassis 104. (See FIGS. 1, 3 and 12) The second vibration isolation subassembly 26 is configured to attenuate first motion control arm vibratory motion and second motion control arm vibratory motion. Referring to FIG. 12, in some embodiments, the lower end of the first motion control arm 114 may be attached to a first shaft 122 for rotation therewith (see FIG. 12). A link 128 extending from and rotatable with the first shaft 122 is operatively coupled to the right wheel transmission (not shown) and/or the engine speed control ((not shown). The second vibration isolation subassembly 26 comprises a third pair 28a, 28b of tapered plate mounts rotatably coupling the first shaft 122 to the chassis 104. Similarly, the lower end (not shown) of the second motion control arm 116 may be attached to a second shaft (not shown) for rotation therewith. The second vibration isolation subassembly 26 further comprises a fourth pair of tapered plate mounts (not shown) substantially the same as the third pair 28a, 28b of tapered plate mounts. The fourth pair of tapered plate mounts rotatably couples the second shaft to the chassis 104. Referring to FIGS. 13-15, in some embodiments, each tapered plate mount 28 comprises a base plate 30 having a frusto-conical center portion 32 surrounding a second cylindrical sleeve 34 and coupled to the cylindrical sleeve by an intervening vibratory motion attenuating material 22.

Referring to FIGS. 3 and 16-17, the vibration isolation system 10 has a third vibration isolation subassembly 36 coupling the seat 106 to the chassis 104. The third vibration isolation subassembly 36 configured to attenuate seat vibratory motion. The seat 106 has a seat bottom 124 having front portion 124a and a rear portion 124b spaced from the front portion 124a. The third vibration isolation subassembly 36 comprises a first compression spring 38 coupling the front portion 124a of the seat bottom 124 to the chassis 104 and a second compression spring 40 coupling the rear portion 124b of the seat bottom 124 to the chassis 104. The first compression spring 38 comprises a pair of L-shaped spring steel curved plates and the second compression spring 40 comprises a pair of spring tubes.

In some embodiments, the seat 106 has a seat back 126 and the third vibration isolation subassembly 36 further comprises a flexing bracket 42 coupling the seat back 126 to the seat bottom 124.

The foregoing detailed description of the invention has been disclosed with reference to specific embodiments. However, the disclosure is not intended to be exhaustive or to limit the invention to the precise forms disclosed. Those skilled in the art will appreciate that changes could be made to the embodiments described above without departing from the broad inventive concept thereof. Therefore, the disclosure is intended to cover modifications within the spirit and scope of the present invention as defined by the appended claims.

We claim:

1. A vibration isolation system for a lawn mover having a chassis supporting a foot platform, a first motion control arm, a second motion control arm and a seat, the vibration isolation system comprising:
a first vibration isolation subassembly coupling the foot platform to the chassis, the first vibration isolation subassembly configured to attenuate foot platform vibratory motion;
a second vibration isolation subassembly coupling the first motion control arm and the second motion control arm to the chassis, the second vibration isolation subassembly configured to attenuate first motion control arm vibratory motion and second motion control arm vibratory motion; and
a third vibration isolation subassembly coupling the seat to the chassis, the third vibration isolation subassembly configured to attenuate seat vibratory motion.

2. The vibration isolation system of claim 1, wherein the foot support platform has a front portion and a rear portion spaced from the front portion and the first vibration isolation subassembly comprises a first pair of vibratory motion attenuating mounts rotatably coupling a front portion of the foot support platform to the chassis and a second pair of energy absorbing mounts coupling the rear portion of the foot support platform to the chassis.

3. The vibration isolation system of claim 2, wherein each vibratory motion attenuating mount is a flange-plate mount comprising a flange plate coupled to a cylindrical sleeve by an intervening vibratory motion attenuating material and each energy absorbing mount is a cylindrical spring tube.

4. The vibration isolation system of claim 2, wherein the first vibration isolation subassembly further comprises at least one stop attached to the chassis, the at least one stop limiting a maximum displacement of the foot support platform.

5. The vibration isolation system of claim 1, wherein the first motion control arm is attached to a first shaft for rotation therewith and the second motion control arm is attached to a second shaft for rotation therewith and
the second vibration isolation subassembly comprises a third pair of tapered plate mounts rotatably coupling the first shaft to the chassis and a fourth pair of tapered plate mounts mounts rotatably coupling the second shaft to the chassis, each tapered plate mount comprising a plate having a frusto-conical center portion surrounding a cylindrical sleeve and coupled to the cylindrical sleeve by an intervening vibratory motion attenuating material.

6. The vibration isolation system of claim 1, wherein the seat has a seat bottom having front portion and a rear portion spaced from the front portion and the third vibration isolation subassembly comprises a first compression spring coupling the front portion of the seat bottom to the chassis and a second compression spring coupling the rear portion of the seat bottom to the chassis.

7. The vibration isolation system of claim 6, wherein the first compression spring comprises a pair of L-shaped spring steel curved plates and the second compression spring comprises a pair of spring tubes.

8. The vibration isolation system of claim 7 wherein the seat has a seat back and the third vibration isolation subassembly further comprises a flexing bracket coupling the seat back to the seat bottom.
